(19) United States
(12) Patent Application Publication
(10) Pub. No.: US 2014/0021194 A1
(43) Pub. Date: Jan. 23, 2014

(54) MAIN CARTRIDGE HEATING JACKET

(71) Applicants: Gregory A. Griffin, Glendale Heights, IL (US); Timothy Yoon, Northbrook, IL (US); Jeffrey R. Kelso, Fort Wayne, IN (US); David J. Nicholls, New Haven, IN (US); Jason B. Arriaga, Fort Wayne, IN (US)

(72) Inventors: Gregory A. Griffin, Glendale Heights, IL (US); Timothy Yoon, Northbrook, IL (US); Jeffrey R. Kelso, Fort Wayne, IN (US); David J. Nicholls, New Haven, IN (US); Jason B. Arriaga, Fort Wayne, IN (US)

(73) Assignee: International Engine Intellectual Property Company, LLC, Lisle, IL (US)

(21) Appl. No.: 14/008,716

(22) PCT Filed: Aug. 26, 2011
(86) PCT No.: PCT/US11/49334

§ 371 Date: Sep. 30, 2013

Related U.S. Application Data
(60) Provisional application No. 61/469,383, filed on Mar. 30, 2011.

(51) Int. Cl. F01N 3/20; H05B 3/42

(52) U.S. Cl. CPC F01N 3/206; H05B 3/42
USPC 219/494; 219/535

(57) ABSTRACT

A heating jacket for use with an ammonia-containing storage cartridge for the controlled release of ammonia into an exhaust stream for the reduction of NOₓ is disclosed. The heating jacket includes an upper section comprising a plurality of layered materials, a lower section comprising a plurality of layered materials, a tool-less locking mechanism for securing the upper and lower sections, wherein the upper and lower sections together form an interior space for the receiving an ammonia-containing material canister. The heating jacket may also include a temperature regulating device within one of the upper section and the lower section for maintaining an activating temperature within a predefined limit for the controlled release of ammonia into the exhaust stream.

### TECHNICAL FIELD

The present device relates to the storage and delivery of ammonia. Particularly, the device relates to a heating jacket for regulating and maintaining the heat around a main NH₃ cartridge, which contains an ammonia-containing material capable of releasing gaseous ammonia for use in the selective catalytic reduction of NOₓ in the exhaust stream of a vehicle.

### BACKGROUND

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes is being employed in a growing number of systems.

One such system is the direct addition of ammonia gas to the exhaust stream in conjunction with an aftertreatment device. It is an advantage to deliver ammonia directly in the form of a gas, both for simplicity of the flow control system and for efficient mixing of reducing agent, ammonia, with the exhaust gas. The direct use of ammonia also eliminates potential difficulties related to blocking of the dosing system, which are cause by precipitation or impurities, e.g., in a liquid-based urea solution. In addition, an aqueous urea solution cannot be dosed at a low engine load since the temperature of the exhaust line would be too low for complete conversion of urea to ammonia (and CO₂).

Transporting ammonia as a pressurized liquid, however, can be hazardous if the container bursts caused by an accident or if a valve or tube breaks. In the case of using a solid storage medium, the safety issues are much less critical since a small amount of heat is required to release the ammonia and the equilibrium pressure at room temperature can be—if a proper solid material is chosen—well below 1 bar. Solid ammonia can be provided in the form of disks or balls loaded into the cartridge or canister. The cartridges are then loaded into a mantle or other storage structure and secured to the vehicle for use. Appropriate heat is applied to the cartridges, which then causes the ammonia-containing solid storage material to release its ammonia gas into an after-treatment device and the exhaust system of a vehicle, for example. Therefore, regulating and maintaining the heat around the cartridges is important for consistent and efficient release of ammonia into the exhaust stream, and more effective reduction of NOₓ. An efficient system requires that multiple cartridge system configurations be heated sequentially, with only one cartridge being actively heated at a time. Furthermore, it is desirable to provide heating to the cartridges during all vehicle operations. The present device provides these features. The present device also provides quick and easy access to the retained ammonia canisters for removal, repair, or inspection through use of a tool-less latching mechanism. The disclosed device is easy to use and relatively inexpensive to manufacture and install.

### SUMMARY

There is disclosed herein a device and method, each of which avoids the disadvantages of prior devices, systems and methods while affording additional structural and operating advantages.

Generally speaking, a heating device comprising a multi-layered heating jacket is disclosed, for securing and heating an ammonia-containing storage cartridge for use on a vehicle.

In one embodiment, the heating jacket comprises first and second complimentary adjacent sections defining an interior space for receiving an ammonia-containing cartridge, the sections aligning with one another along peripheral seams, a heating element disposed within the first and second sections, a locking mechanism for securing and releasing the first and second sections around the cartridge.

In another embodiment, the sections of the heating jacket comprise a plurality of layered materials, including an internal heated surface layer, a heating element sheet layer, an insulation layer and an outer shell.

A method for regulating a temperature applied to an ammonia-containing storage cartridge for use in the treatment of NOₓ in an exhaust stream, is described. The method comprises the steps of affixing a multi-layered heating jacket having an interior surface to a frame of a vehicle, placing an ammonia-containing material storage cartridge within the interior space of the heating jacket, providing a heating means within the heating jacket; and, regulating an activation temperature of the heating jacket and storage cartridge.

These and other aspects of the invention may be understood more readily from the following description and the appended drawings.

### BRIEF DESCRIPTION OF THE DRAWINGS

FIG. 1 is a schematic view of an Exhaust Gas NOₓ Reduction (EGNR) system;

FIG. 2 is an exploded view of the present heating jacket;

FIG. 3 is a perspective view of the present heating jacket;

FIG. 4 is perspective view of the present heating jacket showing the latching mechanism; and,

Appendix

### DETAILED DESCRIPTION

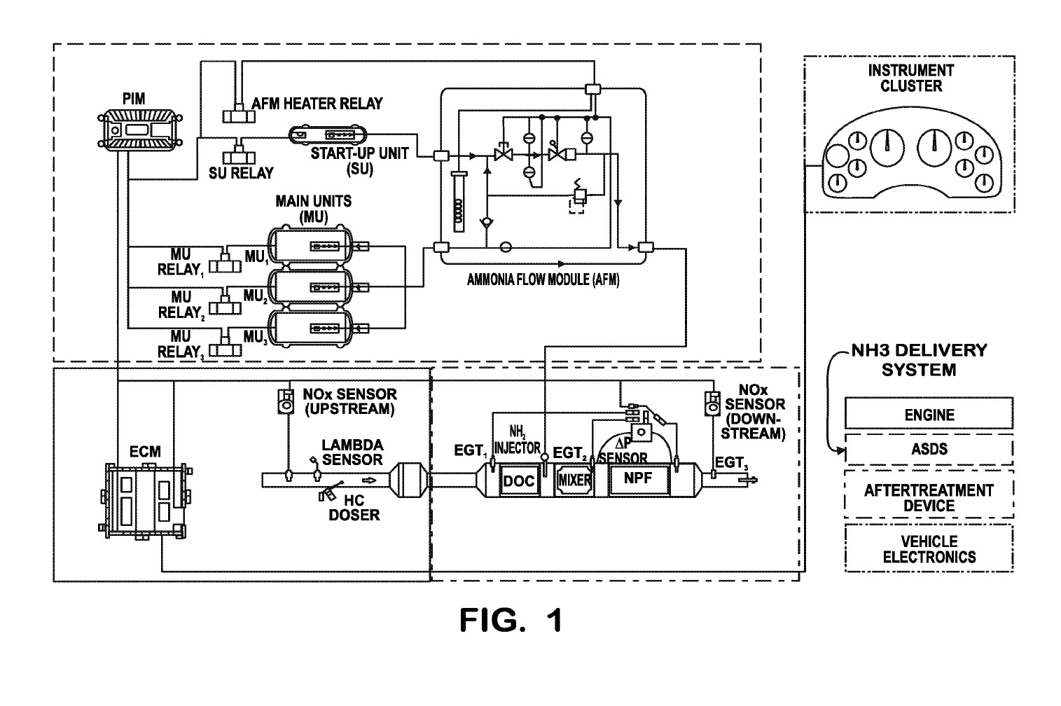

Referring to FIGS. 1-4 and the Appendix, there is illustrated a system and method for storage of ammonia, specifically in a solid form, and delivery of gaseous ammonia for use in the reduction of NOₓ in an exhaust stream. FIG. 1 illustrates an exhaust gas NOₓ reduction system (EGNR), including the ammonia delivery system schematic, in which a series of cartridges or canisters containing a solid ammonia material, specifically for supplying ammonia gas to an after-treatment device for use in the exhaust system of a compression ignition engine (not shown). The components of the EGNR will not be discussed in further detail with the exception of how it relates to the present system. As the exhaust system of a vehicle, including that of a diesel engine, is well known, it will not be described in detail.

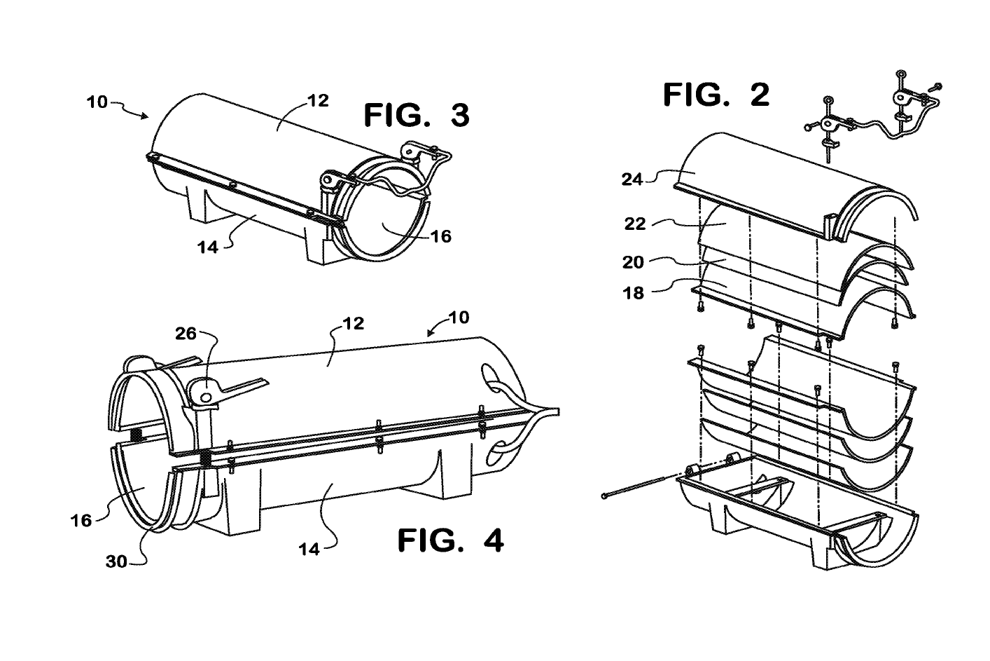

Referring to FIGS. 2-4, there is illustrated a device, and specifically a heating jacket, generally designated by the numeral 10, for regulating and maintaining an activation temperature for a NH₃ cartridge. The heating jacket would be attached to the frame of a vehicle (not shown) using any holder (not shown) permitting easy installation and removal of the jacket and its cartridges. However, the particular holder may be used for retaining any type of suitable replaceable storage tank, including water tanks, air tanks, and the like.

The heating jacket 10 is typically comprised of two halves or sections, a first upper section 12 and a second lower section 14, the sections forming a clamshell-like structure. The sections 12, 14 fit together to define an interior space 16, where the canisters or cartridges (not shown) may be placed. In the illustrated embodiment, the jacket 10 is designed for surrounding an individual cartridge. However, it should be understood that a single jacket 10 may be designed to handle multiple cartridges.

As shown in FIG. 2, each section 12, 14 of the jacket are constructed from a plurality of layered materials. Specifically, the sections include an interior heated surface layer (metallic wear plate) 18 constructed of a suitable heat conductive material, such as aluminum; a heating element sheet 20 constructed of a silicone encased resistive wire mesh; an insulation layer 22 constructed of any suitable insulation material such as foam or fiberglass; and an outer shell 24 constructed of any suitable durable material, such as a glass-filled polymer (nylon). It should be understood this is a representative example of the layered constructions of the present device, and that the materials used therein may vary according to the requirements of the application. The layered material sections insulate and directed the heat energy supplied toward the solid ammonia-containing material stored within the cartridge (not shown), while isolating the heat source from the surrounding environment and its temperature influences. In this manner, the heating jacket 10 provides the appropriate and consistent amount of heat in terms of the correct temperature and duration of heating to sufficiently release the ammonia gas from the ammonia-containing material.

The first section 12 is secured to the second section 14 in a movable manner, using any typical securing device, such a hinge, bolts or screws, to allow insertion and removal of storage cartridges from the interior space 16. It should be understood that any form of movable attachment mechanism, which allows the sections to easily open apart from one another would be suitable in the present device. In an embodiment, the two sections are secured together using a tool-less locking mechanism. For example, as shown in FIG. 4, a pivotal lever or toggle lever 26 connected to a securing bolt 30 is used. The lever 26 is simply lifted upward without the need for any special tools, releasing the securing bolt 20, to separate the two sections from one another. Once the cartridge is removed or loaded into the heating jacket, the lever 26 can be pushed downward, wherein the securing bolt locks the two sections together. Using this type of locking mechanism avoids the need for special tools or other devices.

Heating of the cartridge within the heating jacket 10 may be accomplished through a use of a heating element (not shown), such as a resistive element which generates heat when an electrical current is passed through the element, or a conduit for a liquid, such as engine coolant. The heating element may be installed within the heating element sheet layer 20 part of the layered structure forming both sections 12, 14 of the jacket. Although not shown, it should be understood that the heating element is connected to a power source (not shown) and control device, such as an electronic control module (not shown) to control the amount of heat generated by the heating jacket, as well as the duration of heating. Similarly, the heating jacket 10 may include an integrated temperature detection device (thermistor) and pressure sensors (not shown) for sending appropriate signals to an electronic control module (not shown) for monitoring and controlling the heating element of the heating jacket, even controlling the sequential heating of multiple jackets in the system. In this manner, the heating can be controlled within predefined limits, such that it does not damage surrounding components or even the ammonia-containing material within the cartridges.

What is claimed is:

1. A heating jacket comprising:
first and second complimentary adjacent sections defining an interior space for receiving an ammonia-containing cartridge, the sections aligning with one another along peripheral seams;
a heating element disposed within the first and second sections; and,
a locking mechanism for securing and releasing the first and second sections around the cartridge.

2. The heating jacket of claim 1, wherein the first section and the second sections include connectors along the peripheral seams for joining the first section with the second section.

3. The heating jacket of claim 2, wherein the connectors include a hinge.

4. The heating jacket of claim 1, wherein the first and second sections are comprised of a plurality of layered materials.

5. The heating jacket of claim 4, wherein one of the layers of the first and second sections includes a controllable heating element disposed therein.

6. The heating jacket of claim 1, wherein the locking mechanism includes a pivotal lever.

7. The heating jacket of claim 1, wherein the device further includes a temperature regulator.

8. The heating jacket of claim 1, wherein the temperature regulator includes an integrated temperature detection device.

9. A heating jacket for use in the controlled release of ammonia in an exhaust stream for the reduction of NOₓ, the jacket comprising:
an upper section comprising a plurality of layered materials;
a lower section comprising a plurality of layered materials;
a tool-less locking mechanism for securing the upper and lower sections, wherein the upper and lower sections together form an interior space for the receiving an ammonia-containing material canister; and,
a temperature regulating device within one of the upper section and the lower section for maintaining an activating temperature within a predefined limit for the controlled release of ammonia into the exhaust stream.

10. A method for regulating a temperature applied to a solid ammonia storage cartridge for use in the treatment of NOₓ in an exhaust stream, the method comprising the steps of:
affixing a restraint device to a frame of a vehicle;
providing a multi-layered heating jacket defining an interior space within the restraint device;
placing the solid ammonia storage cartridge within the interior space of the heating jacket;
securing the heating jacket around the cartridge;
providing a heating means within the heating jacket; and,
regulating an activation temperature of the heating jacket and storage cartridge.

11. The method of claim 10, wherein the step of securing the heating jacket around the cartridge comprises providing a tool-less closure.

12. The method of claim 10, wherein the tool-less closure comprises a lever.

13. The method of claim 10, wherein the heating means comprises a plurality of electronic heating elements disposed within the heating jacket.

14. The method of claim 10, wherein the step of regulating the activation temperature of the heating jacket and storage cartridge further comprises maintaining the activation temperature for release of ammonia from the solid ammonia storage cartridge.
